(19) United States
(12) Patent Application Publication
(10) Pub. No.: US 2001/0046296 A1
(43) Pub. Date: Nov. 29, 2001

(54) Encryption method and cryptographic communication method

(75) Inventors: Kiyoko Katayanagi, Otsu-shi (JP); Yasuyuki Murakami, Kyoto-shi (JP); Masao Kasahara, Mino-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 09/758,618

(22) Filed: Jan. 10, 2001

(30) Foreign Application Priority Data
Jan. 12, 2000 (JP) 2000-3999

(51) Int. Cl. H04N 7/167

(52) U.S. Cl. 380/210

(57) ABSTRACT

After converting each of characters in a plaintext into binary data, the respective binary data are sequentially connected to form a block of a predetermined number of bits. When binary data can not be inserted in the end portion of each block due to a shortage of the number of bits, dummy data as the digit “0” is added to that portion in a length corresponding to a necessary number of bits so as to form a block consisting of a predetermined number of bits in total. Information indicating the number of bits of this dummy data is added to the end of the plaintext or ciphertext.

### BACKGROUND OF THE INVENTION

The invention relates to an encryption method for encrypting information contents so as to mask it from those other than the parties concerned, a cryptographic communication method for communication in a ciphertext, and memory product/data signal embodied in carrier wave for recording/transmitting a operation programs for this encryption method.

In the modern society, called a highly information-oriented society, based on a computer network, important business documents and image information are transmitted and communicated in a form of electronic information. Such electronic information can be easily copied, so that it tends to be difficult to discriminate its copy and original from each other, thus bringing about an important issue of data integrity. In particular, it is indispensable for establishment of a highly information oriented society to implement such a computer network that meets the factors of “sharing of computer resources,” “multi-accessing,” and “globalization,” which however includes various factors contradicting the problem of data integrity among the parties concerned. In an attempt to eliminate those contradictions, encrypting technologies which have been mainly used in the past military and diplomatic fields in the human history are attracting world attention as an effective method for that purpose.

A cipher communication is defined as exchanging information in such a manner that no one other than the parties concerned can understand the meaning of the information. In the cipher communication, encryption is defined as converting an original text (plaintext) that can be understood by anyone into a text (ciphertext) that cannot be understood by the third party and decryption is defined as restoring a ciphertext into a plaintext, and cryptography is defined as the overall processes covering both encryption and decryption. The encrypting and decrypting processes use secret information called an encryption key and a decryption key, respectively. Since the secret decryption key is necessary in decryption, only those knowing this decryption key can decrypt ciphertexts, thus maintaining data security.

The encryption key and the decryption key may be either the same or different from each other. A cryptography using the same key is called a common-key cryptography, and DES (Data Encryption Standards) employed by the Standard Agency of the USA Commerce Ministry is a typical example. As an example of the cryptography using the keys different from each other, a cryptography called a public-key cryptography has been proposed. In the public-key cryptography, each user (entity) utilizing this cryptography generates a pair of encryption and decryption keys and publicizes the encryption key in a public-key list, thereby keeping only the decryption key in secret. In this public-key cryptography, the paired encryption and decryption keys are different from each other, so that the public-key cryptography has a feature that the decryption key cannot be known from the encryption key with a one-way function.

In either of such cryptography, there is one adopting a system of converting a plaintext into a ciphertext block by block, each block consisting of a predetermined number of bits. In this block cipher system, binary data representing the respective characters in the plaintext are connected sequentially to form a block, and the formed block is encrypted as a unit.

In such a block cipher system, the number of bits in one block is limited, and the binary data of a single character is not split over two blocks. Hence, there may be a case where one block is not completely stuffed with a plurality of binary data representing a plurality of characters and the remainder occurs. Then, in order to arrange the number of bits in a single block to be a predetermined number of bits, after adding dummy data consisting of a sequence of “0” digits necessary for constituting one block, an encryption process is performed to obtain the ciphertext.

Since all the data in the dummy data are “0”, it is possible to correctly decrypt the ciphertext without being affected by the dummy data. However, during the decryption, it is impossible to identify whether the encrypted “0” is derived from the dummy data or is a part of the authentic ciphertext, and thus there is a problem that the data of the original plaintext and the data of the plaintext recovered by decryption are recognized as different data.

### BRIEF SUMMARY OF THE INVENTION

An object of the present invention is to provide an encryption method capable of accurately recognizing the presence of dummy data by adding information indicating the number of bits of the dummy data to a plaintext or a ciphertext and thereby always accurately decrypting the ciphertext into a plaintext having a data structure identical with the data of the original plaintext, a cryptographic communication method using this encryption method, and a recording medium/transfer medium for recording/transferring an operation program of this encryption method.

An encryption method of the first aspect of the present invention encrypts a plaintext of characters, each represented by binary data of a plurality of bits, into a ciphertext block by bock, each block consisting of a predetermined number of bits; supplements the remainder within a block other than the plaintext by dummy data so that the block consists of the predetermined number of bits; and adds information indicating the number of bits of the dummy data to the plaintext.

An encryption method of the second aspect of the present invention encrypts a plaintext of characters, each represented by binary data of a plurality of bits, into a ciphertext block by bock, each block consisting of a predetermined number of bits; supplements the remainder within a block other than the plaintext by dummy data so that the block consists of the predetermined number of bits; and adds information indicating the number of bits of the dummy data to the ciphertext.

In the present invention, encryption is performed by adding information indicating the number of bits of dummy data supplemented to arrange the number of bits in a block to be a predetermined number bits, or the information indicating the number of bits of the dummy data is added to the ciphertext obtained by encrypting the plaintext and dummy data. Therefore, during the decryption of the ciphertext, since the information indicating the number of bits of the dummy data has been incorporated into the ciphertext, it is possible to accurately recognize the number of bits of the dummy data in the block and decrypt the ciphertext into a plaintext having a data structure identical with the data of the original plaintext.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic diagram showing the structure of a cryptographic communication system using an encryption method and a cryptographic communication method of the present invention;

FIG. 2 is a schematic diagram showing a communication state of cryptographic information between two entities;

FIG. 3 is an illustration showing one block of plaintext according to the first embodiment;

FIG. 4A is an illustration showing one block of plaintext according to the second embodiment;

FIG. 4B is an illustration showing a ciphertext corresponding to one block of plaintext according to the second embodiment; and

FIG. 5 is an illustration showing the structure of an embodiment of a memory product.

### DETAILED DESCRIPTION OF THE INVENTION

The present invention will be described in detail below with reference to the drawings illustrating the embodiments thereof

The following description explains one example of an information communication system using cryptography called the “ID-NIKS (ID-based non-interactive key sharing scheme)” which uses ID (identity) information identifying an individual, such as the name, address and telephone number of each entity, and shares an encryption key and a decryption key by using the ID information of the other party in communication without the need for preliminary communication. This ID-NIKS cryptography is a system which does not require exchange of the public key and secret key between the sender and recipient, a list of keys, nor service from the third party, thereby enabling safe communications between any intended entities.

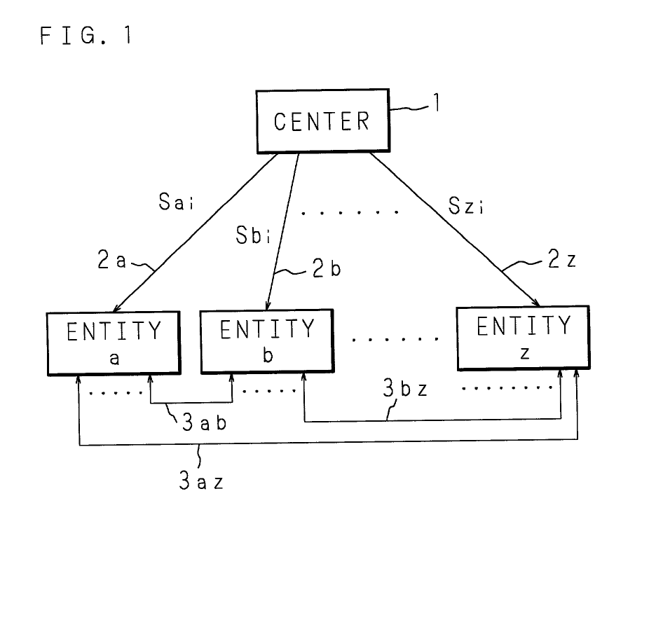

FIG. 1 is a schematic diagram showing the structure of a cryptographic communication system using an encryption method and a cryptographic communication method of the present invention. A center 1 that can be trusted for the secrecy of information is set and, for example, a public organization in the society can correspond to this center 1. A plurality of entities a, b, . . . , z as the users of this cryptographic communication system are connected to the center 1 via secret communication channels 2a, 2b, . . . , 2z, and secret key information is transmitted to the entities a, b, . . . , z from the center 1 via these secret communication channels 2a, 2b, . . . , 2z, respectively. Moreover, communication channels 3ab, 3az, 3bz, . . . are provided between two entities so that a ciphertext given by encrypting communicating information is transmitted between the entities via the communication channels 3ab, 3az, 3bz, . . . .

The ID information of the entity a is represented by h(IDₐ) using a hash function h(·). For any intended entity a, the center 1 calculates secret information Sₐᵢ based on center public information {PCᵢ}, center secret information {SCᵢ} and the ID information h(IDₐ) of the entity a as given by equation (1) below, and distributes the secret information Sₐᵢ in secrecy to the entity a.

Sₐᵢ=Fᵢ({Scᵢ},{PCᵢ},h(IDₐ)) (1)

Similarly, for other entities b, . . . , z, secret information S_{bi}, . . . , S_{zi} are calculated by the center 1 and distributed in secrecy to the entities b, . . . , z, respectively.

The entity a calculates a common key K_{ab} for use with any other intended entity b for encryption and decryption by the use of its own secret information {Sₐᵢ}, the center public information {PCᵢ} and the ID information h(ID_{b}) of the entity b as the other party as given by equation (2) below.

K_{ab}=f({Sₐᵢ},{PCᵢ},h(ID_{b}) (2)

Besides, the entity b generates a common key K_{ba} for use with the entity a in a similar manner. This generated common key K_{ba} and the common key K_{ab} generated on the entity a side are identical, and the common keys K_{ab} and K_{ba} can be used as a common encryption key/decryption key between the entities a and b.

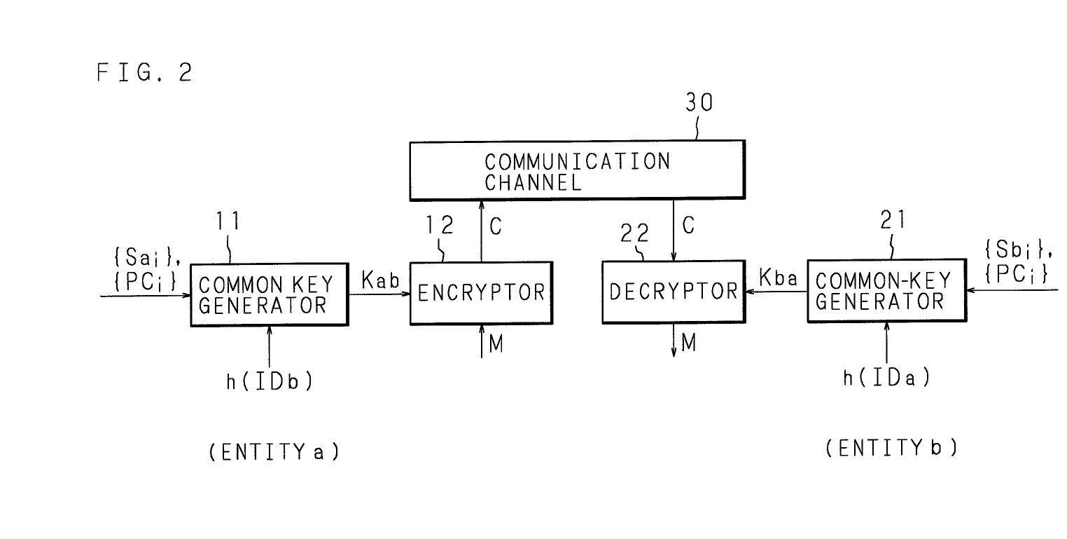

Next, the following description will explain cryptographic information communications between entities according to the above-described system. FIG. 2 is a schematic diagram showing a communication state of cryptographic information between two entities a and b. In the example illustrated in FIG. 2, the entity a encrypts a plaintext M into a ciphertext C and transmits the ciphertext C to the entity b, while the entity b decrypts the ciphertext C into the original plaintext M.

The entity a is provided with a common key generator 11 for receiving its own secret information {Sₐᵢ} and the center public information {PCᵢ} sent from the center 1 and the ID information h(ID_{b}) of the entity b as the other party and for generating a common key K_{ab} desired by the entity a for use with the entity b, based on the received information; and an encryptor 12 for encrypting a plaintext M into a ciphertext C by the use of the common key K_{ab} and for outputting the ciphertext C to a communication channel 30.

Meanwhile, the entity b is provided with a common key generator 21 for receiving its own secret information {S_{bi}} and the center public information {PCᵢ} sent from the center 1 and the ID information h(IDₐ) of the entity a as the other party and for generating a common key K_{ba} desired by the entity b for use with the entity a, based on the received information; and a decryptor 22 for decrypting the ciphertext C input from the communication channel 30 into the plaintext M by the use of the common key K_{ba} and for outputting the plaintext M.

Next, the operation will be explained. In the case where information is to be transmitted in the form of a ciphertext from the entity a to the entity b, first, the common key K_{ab} is calculated according to equation (2) shown above in the common key generator 11, based on the secret information {Sₐᵢ} of the entity a itself, the center public information {PCᵢ} and the ID information h(ID_{b}) of the entity b as the other party, and then sent to the encryptor 12. In the encryptor 12, the plaintext M is encrypted into the ciphertext C by the use of this public key K_{ab}, and the ciphertext C is transmitted via the communication channel 30.

The ciphertext C transmitted via the communication channel 30 is input to the decryptor 22 of the entity b. The common key K_{ba} is calculated according to equation (2) shown above in the common key generator 21, based on the secret information {S_{bi}} of the entity b itself, the center public information {PCᵢ} and the ID information h(IDₐ) of the entity a as the other party, and then sent to the decryptor 22. In the decryptor 22, the ciphertext C is decrypted into the plaintext M by the use of this public key K_{ba}.

The following description will explain a block encrypting process as a characteristic feature of the present invention, according to a cryptographic communication system shown in FIG. 2. In the present invention, after converting the respective characters in a plaintext into binary data, the respective binary data are sequentially connected to form a block of 64 bits. At this time, if binary data can not be inserted in the end portion of each block due to a shortage of the number of bits, dummy data as the digit “0” is added to that portion in a length corresponding to the shortage of the number of bits so as to form a block consisting of 64 bits in total. In the present invention, information indicating the number of bits of the dummy data is added to the end of a plaintext or a ciphertext. Alternatively, it is possible to add the information indicating the number of bits of the dummy data to the head of a plaintext or a ciphertext.

(First Embodiment)

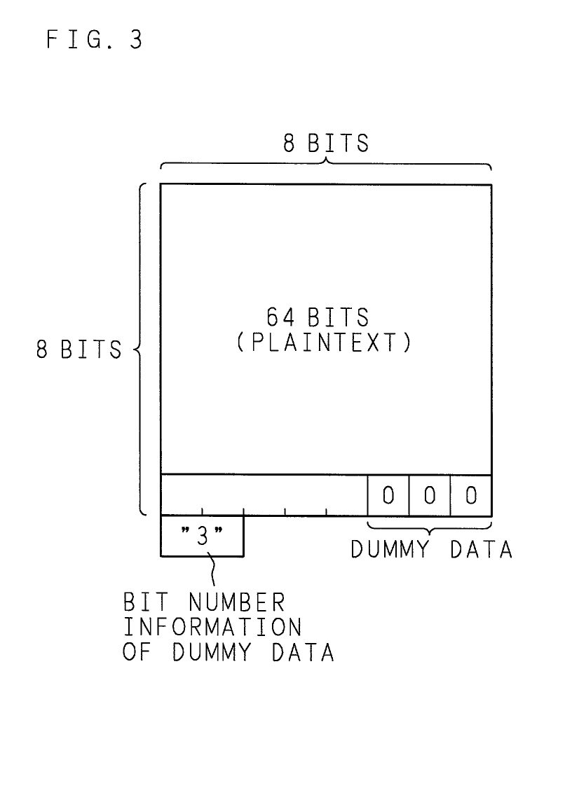

In the first embodiment, the information indicating the number of bits of dummy data is added to the end of a plaintext. FIG. 3 is an illustration showing one block of plaintext according to the first embodiment. One block consists of binary data of 64 bits in total: 8 bits high by 8 bits wide, and the last three bits are dummy data. Besides, the information “3” indicating the number of bits of the dummy data is added to the end of the block. Each block having such a structure is encrypted into the ciphertext in the encryptor 12 by the use of the common key K_{ab}.

In the decryptor 22, this ciphertext is decrypted by the use of the common key K_{ba}. Since the information “3” indicating the number of bits of the dummy data has been incorporated into this cipher text, the number of bits in the dummy data in the block can be accurately recognized. It is therefore possible to correctly distinguish between the data of the plaintext and the dummy data and to accurately decrypt the ciphertext into a plaintext having a data structure identical with the data of the original plaintext.

(Second Embodiment)

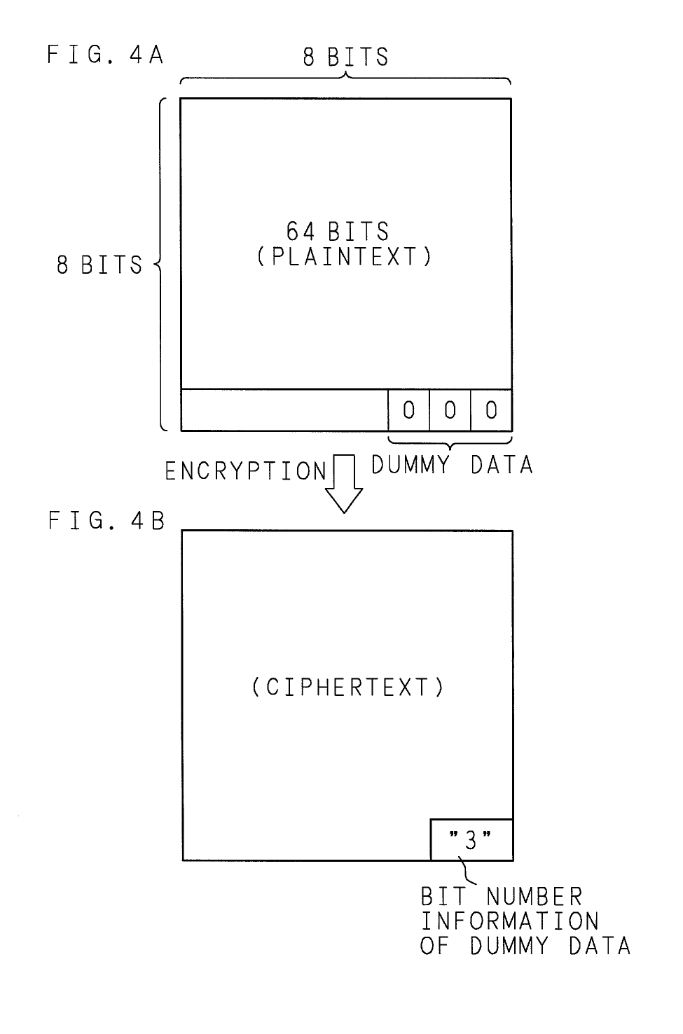

In the second embodiment, the information indicating the number of bits of the dummy data is added to the end of the ciphertext. FIGS. 4A and 4B are illustrations showing one block of plaintext and a ciphertext corresponding to the one block of plaintext, respectively, according to the second embodiment. One block of plaintext consists of binary data of 64 bits in total: 8 bits high by 8 bits wide, and the last three bits are dummy data. Besides, this plaintext and the dummy data are encrypted into a ciphertext in the encryptor 12 by the use of the common key K_{ab}. During the encryption, the information “3” indicating the number of bits of the dummy data is added to the end of the ciphertext.

In the decryptor 22, this ciphertext including the information “3” is decrypted by the use of the common key K_{ab}. Since the information “3” indicating the number of bits in the dummy data has been incorporated into this ciphertext, the number of bits in the dummy data in the block can be accurately recognized. It is thus possible to correctly distinguish between the data of the plaintext and the dummy data and to accurately decrypt the ciphertext into a plaintext having a data structure identical with the data of the original plaintext.

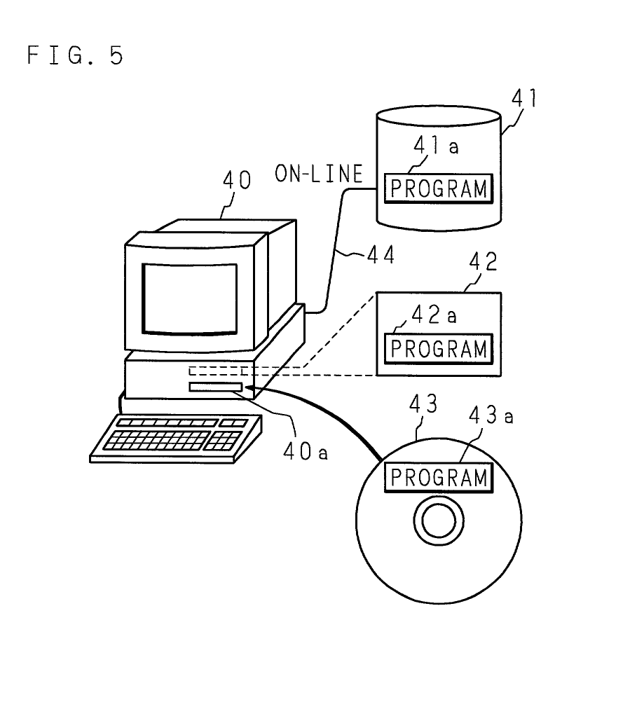

FIG. 5 is an illustration showing the structure of an embodiment of a memory product of the present invention. The program illustrated as an example here includes a process of creating a ciphertext from a plaintext, particularly a process of adding the information indicating the number of bits of dummy data to the plaintext or the ciphertext, which is a characteristic feature of the present invention, and is recorded on a memory product to be explained below. Besides, a computer 40 is provided for each entity.

In FIG. 5, a memory product 41 to be on-line connected to the computer 40 is implemented using a server computer of, for example, WWW (World Wide Web), located in a place distant from the installation location of the computer 40, and a program 41a as mentioned above is recorded on the memory product 41. The program 41a read from the memory product 41 via a transfer medium 44 such as a communication line controls the computer 40 to add the information indicating the number of bits of dummy data to a plaintext or a ciphertext so as to create a ciphertext.

A memory product 42 provided inside the computer 40 is implemented using, for example, a hard disk drive or a ROM to be installed in the computer 40, and a program 42a as mentioned above is recorded on the memory product 42. The program 42a read from the memory product 42 controls the computer 40 to add the information indicating the number of bits of dummy data to a plaintext or a ciphertext so as to create a ciphertext.

A memory product 43 used by being loaded into a disk drive 40a installed in the computer 40 is implemented using, for example, a magneto-optical disk, CD-ROM, flexible disk or the like which is portable, and a program 43a as mentioned above is recorded on the memory product 43. The program 43a read from the memory product 43 controls the computer 40 to add the information indicating the number of bits of dummy data to a plaintext or a ciphertext so as to create a ciphertext.

Further, in the above-described examples, although the ID-NIKS cryptography has been explained, this cryptography is merely an example and the present invention is certainly applicable to every cryptography adopting a block cipher system.

In the present invention, as described above, since the information indicating the number of bits in dummy data according to the block cipher system is added to a plaintext or a ciphertext, it is possible to recognize the number of bits of the dummy data during decryption, correctly distinguish between the plaintext and the dummy data, and accurately decrypt the ciphertext into a plaintext having data identical with the data of the original plaintext. Therefore, the present invention can contribute to the development of cryptosystem.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An encryption method comprising the steps of:
encrypting a plaintext of characters, each represented by binary data of a plurality of bits, into a ciphertext block by block; and
supplementing a remainder within each block other than the plaintext by dummy data so that each block consists of a predetermined number of bits,
wherein information indicating the number of bits of the dummy data is added to the plaintext.

2. An encryption method comprising the steps of:
encrypting a plaintext of characters, each represented by binary data of a plurality of bits, into a ciphertext block by block; and
supplementing a remainder within each block other than the plaintext by dummy data so that each block consists of a predetermined number of bits,
wherein information indicating the number of bits of the dummy data is added to the ciphertext.

3. An encryption method for encrypting a plaintext into a ciphertext block by block, each block consisting of a predetermined number of bits, comprising the step of:
forming a block of plaintext by binary data of plaintext and dummy data;
adding information indicating the number of bits of the dummy data to the plaintext; and
encrypting the plaintext, the dummy data and the information.

4. An encryption method for encrypting a plaintext into a ciphertext block by block, each block consisting of a predetermined number of bits, comprising the step of:
forming a block of plaintext by binary data of plaintext and dummy data;
encrypting the plaintext and the dummy data; and
joining information indicating the number of bits of the dummy data to a result of the encryption so as to obtain a ciphertext.

5. A cryptographic communication method for performing cryptographic information communication between a plurality of entities, comprising the steps of:
obtaining a ciphertext from a plaintext at a first entity;
transmitting the obtained ciphertext to a second entity; and
decrypting the transmitted ciphertext into a plaintext at the second entity;
wherein said step of obtaining the ciphertext comprises;
forming a block of plaintext by binary data of plaintext and dummy data;
adding information indicating the number of bits of the dummy data to the plaintext; and
encrypting the plaintext, the dummy data and the information.

6. A cryptographic communication method for performing cryptographic information communication between a plurality of entities, comprising the steps of:
obtaining a ciphertext from a plaintext at a first entity;
transmitting the obtained ciphertext to a second entity; and
decrypting the transmitted ciphertext into a plaintext at the second entity;
wherein said step of obtaining the ciphertext comprises;
forming a block of plaintext by binary data of plaintext and dummy data;
encrypting the plaintext and the dummy data; and
joining information indicating the number of bits of the dummy data to a result of the encryption so as to obtain a ciphertext.

7. A computer memory product having computer readable program code means for causing a computer to encrypt a plaintext into a ciphertext block by block, each block consisting of a predetermined number of bits, said computer readable program code means comprising:
program code means for causing the computer to form a block of plaintext by binary data of plaintext and dummy data;
program code means for causing the computer to add information indicating the number of bits of the dummy data to the plaintext; and
program code means for causing the computer to encrypt the plaintext, the dummy data and the information.

8. A computer memory product having computer readable program code means for causing a computer to encrypt a plaintext into a ciphertext block by block, each block consisting of a predetermined number of bits, said computer readable program code means comprising:
program code means for causing the computer to form a block of plaintext by binary data of plaintext and dummy data;
program code means for causing the computer to encrypt the plaintext and the dummy data; and
program code means for causing the computer to join information indicating the number of bits of the dummy data to a result of the encryption so as to obtain a ciphertext.

9. A computer data signal embodied in a carrier wave for transmitting a program, the program being configured to cause a computer to encrypt a plaintext into a ciphertext block by block, each block consisting of a predetermined number of bits, comprising:
a code segment for causing the computer to form a block of plaintext by binary data of plaintext and dummy data;
a code segment for causing the computer to add information indicating the number of bits of the dummy data to the plaintext; and
a code segment for causing the computer to encrypt the plaintext, the dummy data and the information.

10. A computer data signal embodied in a carrier wave for transmitting a program, the program being configured to cause a computer to encrypt a plaintext into a ciphertext block by block, each block consisting of a predetermined number of bits, comprising:
a code segment for causing the computer to form a block of plaintext by binary data of plaintext and dummy data;
a code segment for causing the computer to encrypt the plaintext and the dummy data; and
a code segment for causing the computer to join information indicating the number of bits of the dummy data to a result of the encryption so as to obtain a ciphertext.
